(19) United States
(12) Patent Application Publication
(10) Pub. No.: US 2002/0174098 A1
(43) Pub. Date: Nov. 21, 2002

(54) Method and system for providing a dynamic and real-time exchange between heterogeneous database systems

(75) Inventors: Hsing Kong Wu, Taichung (TW); Shu Hui Tseng, Changhua Hsien (TW); Pai Kang Hsaio, Changhua (TW); Yu Chi He, Taichung (TW); Wei Chou Chen, Taichung City (TW); Ta Yu Lin, Taichung Hsien (TW); Yen Liang Liu, Taichung City (TW)

Correspondence Address: Michael A. Kaufman, Flehr Hohbach Test Albritton & Herbert LLP, Suite 3400, Four Embarcadero Center, San Francisco, CA, 94111-4187, US

(73) Assignee: LASMSOFT CORPORATION

(21) Appl. No.: 09/997,489

(22) Filed: Nov. 19, 2001

(30) Foreign Application Priority Data
May 4, 2001 (TW) 90110774

(51) Int. Cl. G06F 7/00

(52) U.S. Cl. 707/1

(57) ABSTRACT

A system for dynamically exchanging heterogeneous databases in real-time, includes database table migration means for executing data migration by selecting a source database and a destination database, and then selecting source data table as a basis for selecting migration mode; relational table establishing means for defining a displayed relational field and exporting data module after selecting a source database and a source data table; data table export means for executing data export by selecting source database and selecting an export destination file; data table import means for executing data import by selecting a source file and selecting destination table according to said source file selection and setting table mapping field; data mapping rule means for mapping the data field via multiple operation means and an automatically encode and interpretation system after selecting source; screen data control mapping means for mapping a data file for storage and activating application program by selecting data picture, reading screen element, and setting a name of the element for storage and selecting storage element after selecting data picture; and data rule detecting means for setting execution rule and importing schedule after setting executing timing, selecting detected source, and selecting target.

### FIELD OF THE INVENTION

The present invention relates to an information processing system for accessing a database, more particularly, to a database system and a method for providing a dynamic and real-time exchange between heterogeneous database systems.

### BACKGROUND OF THE INVENTION

The database systems in enterprises are changing from a companywide system using a mainframe computer to a departmental system distributed among departments in charge with individual businesses. In order to construct an optimum system according to the contents of individual business, a database management system (DBMS) is employed. As an application programming interface (API) for accessing the databases, a language called SQL (structured query language) is generally used. The standard specification of SQL is provided by ANSI (American National Standards Institute) or the like. However, for actual DBMS products, the standard specification varies from one DBMS vendor to another in detailed points. As a result, the databases on the DBMS of different vendors cannot be accessed with the same SQL. Hence, the task of combining incompatible database system is extremely complex. In addition, SQL mapping cannot be performed dynamically, requiring mapping definitions to be regenerated each time a new and unrecognized foreign database is added.

Furthermore, with the explosive growth of the Internet and World Wide Web, an ever-increasing number of computers of disparate platforms are being connected together each day, leading to an ever-increasing number of heterogeneous networked environments. In order for data to be transmitted effortlessly across platforms, a solution is needed which is not only independent of platform but is also independent of any communication protocol employed.

### SUMMARY OF THE INVENTION

An object of this invention is to provide a database management system which integrates the original data sources operating under different Application Program Interface (API) (e.g., ORACLE, SYBASE, MS SQL, IBM DB2, etc.) and transforms these data sources into text files (e.g., EXCEL, XML, WML format) for utilization by different application systems (e.g., IE Browser, Netscape, EXCEL, WAP phone, EOS, or POS in enterprises) via different transmission interfaces (Internet, Intranet, Mobile network) so as to meet the requirements of electronic commerce.

In order to achieve the object described above, according to the invention, there is provided a database management system (DBMS) for dynamically exchanging heterogeneous databases in real-time, comprising:

database table migration means for executing data migration by selecting a source database and a destination database, and then selecting source data table as a basis for selecting migration mode;

relational table establishing means for defining a displayed relational field and exporting data module after selecting a source database and a source data table;

data table export means for executing data export by selecting source database and selecting an export destination file;

data table import means for executing data import by selecting a source file and selecting destination table according to said source file selection and setting table mapping field;

data mapping rule means for mapping the data field via multiple operation means and an automatically encode and interpretation system after selecting source;

screen data control mapping means for mapping a data file for storage and activating application program by selecting data picture, reading screen element, and setting a name of the element for storage and selecting storage element after selecting data picture; and

data rule detecting means for setting execution rule and importing schedule after setting executing timing, selecting detected source, and selecting target.

Other objects and advantages of the present invention will become apparent from the description which follows hereinafter when taken in conjunction with the drawing figures which accompany it.

### BRIEF DESCRIPTION OF THE DRAWINGS

FIG. 1 is a flowchart of the database table migration means of the DBMS in accordance with the present invention;

FIG. 2 is a flowchart of the relational table establishing means of the DBMS in accordance with the present invention;

FIG. 3 is a flowchart of the data table export means of the DBMS in accordance with the present invention;

FIG. 4 is a flowchart of the data table import means of the DBMS in accordance with the present invention;

FIG. 5 is a flowchart of the data mapping rule means of the DBMS in accordance with the present invention;

FIG. 6 is a flowchart of the screen data control mapping means of the DBMS in accordance with the present invention;

FIG. 7 is a flowchart of the data rule detecting means of the DBMS in accordance with the present invention; and

FIGS. 8-27 illustrate various screens for displaying the operations of the present invention.

### DETAILED DESCRIPTION OF THE PREFERRED EMBODIMENTS

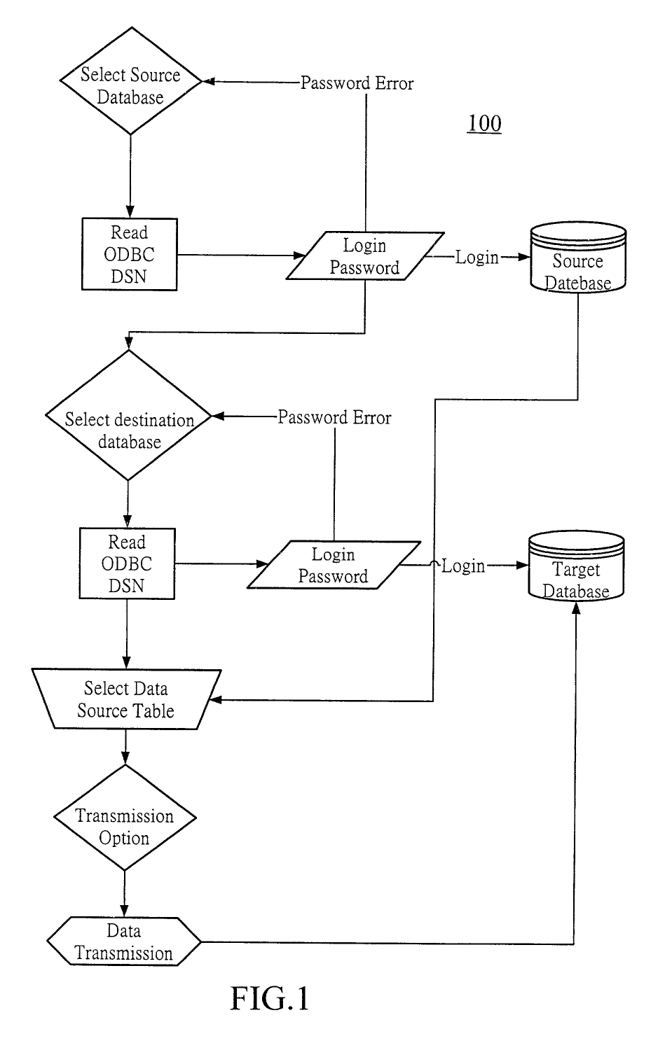

Referring to FIG. 1, a flowchart 100 showing the database table migration means of the DBMS in accordance with the present invention is illustrated. DBMS selects a source database, and the selected database is authenticated by an authentication process and then sent into the database of the DBMS. At the same time, the DBMS selects a destination database, and the selected database is authenticated by an authentication process and then sent into the database of the DBMS. Then, a source data table corresponding to said destination database is obtained from said source database and a migration mode is decided. Thereafter, a data migration is executed for migrating data.

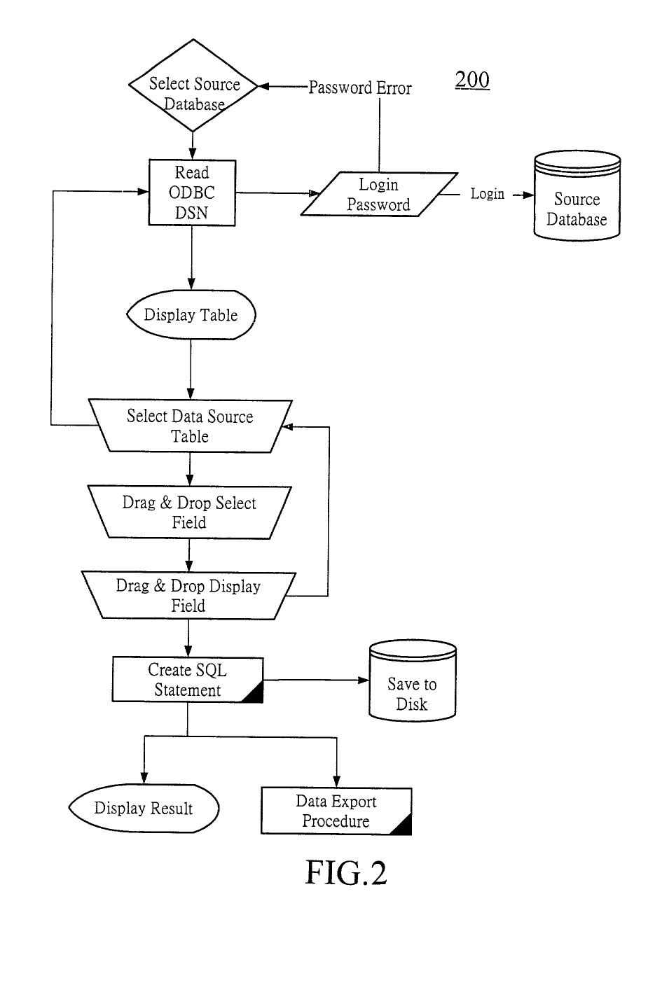

FIG. 2 shows a flowchart 200 of the relational table establishing means of the DBSM in accordance with this invention. The DBMS selects a source database, and the selected database is authenticated by an authentication process and then sent into the database of the DBMS. The DBMS then displays the data table and selects the source data table. The DBMS then sets a relational field and a display field by drag-and-drop actions, then display the resultant data by SQL database statement so as to proceed to a data export process and the SQL statement is stored as to establish the relational table.

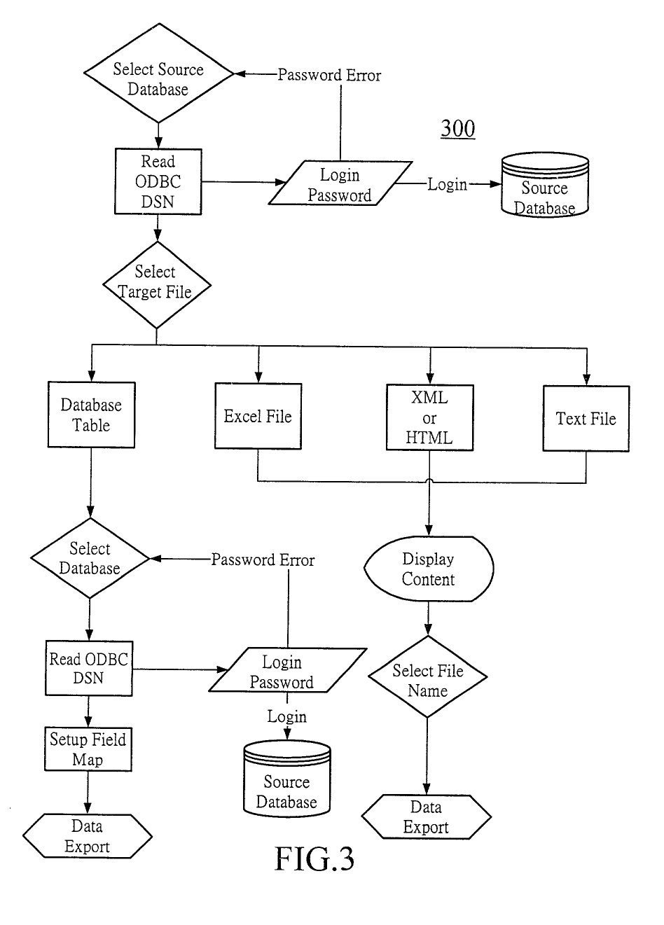

FIG. 3 is a flowchart 300 showing the data table export means of the DBMS in accordance with this invention. The DBMS selects the source database, and the selected database is authenticated by an authentication process. An export destination file is selected, if the destination file is any of the spread sheet file, data file, or text file, then a destination table is decided, data export is executed so as to achieve the export of the data table.

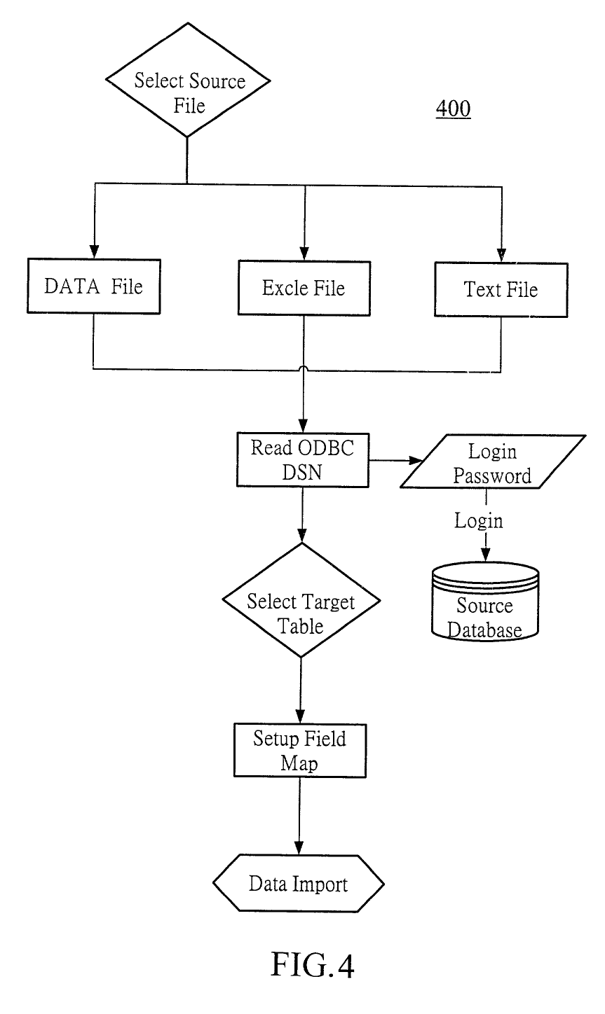

FIG. 4 is a flowchart 400 showing the data table import means of the DBMS in accordance with this invention. The DBMS selects the source database, and the selected database is authenticated by an authentication process. An import destination file is selected, if the destination file is any of the spread sheet file, data file, or text file, then a destination table is decided, data export is executed in reference to a setup table mapping field so as to achieve the import of the data table.

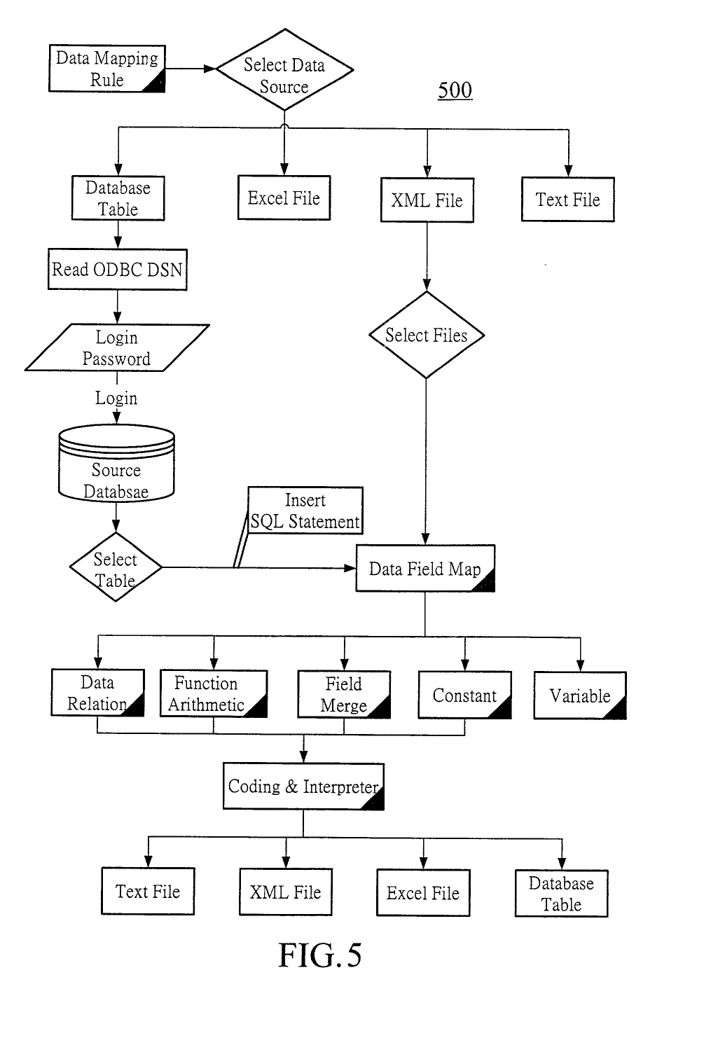

FIG. 5 shows a flowchart 500 of the data mapping rule means of the DBMS in accordance with this invention. The DBMS selects the source database, the selected database is authenticated by an authentication process. The files in the selected database is executed, if the file is any of the data file, spread sheet file, or text file, a data table is decided. A data field setup mapping is executed in cooperation with a multiple operation, such as data table relation operation, functional arithmetic operation, field merge operation, constant operation, and variable operation, etc. Then, the processed data enter the system coding and interpreter, the data is then written into a destination file, such as text file, web page file, spread sheet file, or database table in accordance with said mapping setup.

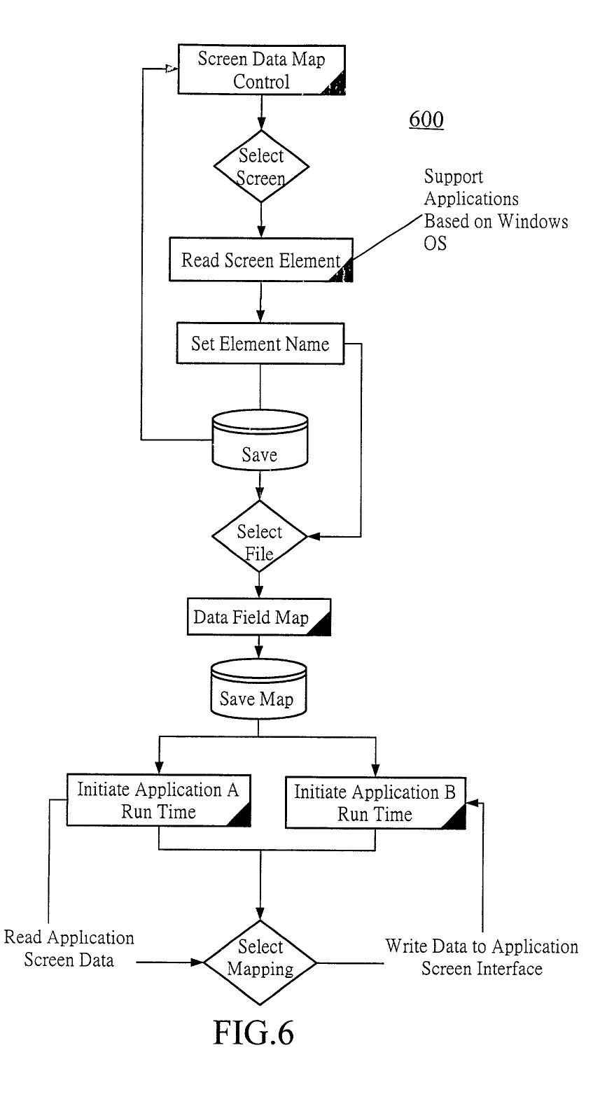

FIG. 6 is a flowchart 600 showing the screen data control mapping means of the DBMS in accordance with this invention. The DBMS selects the screen, then reads the screen elements, and sets the names of elements and stores the elements. Then, a stored element is selected and mapped onto a data file setting. The mapping is then stored and a corresponding application is initiated. Then, a mapping is selected.

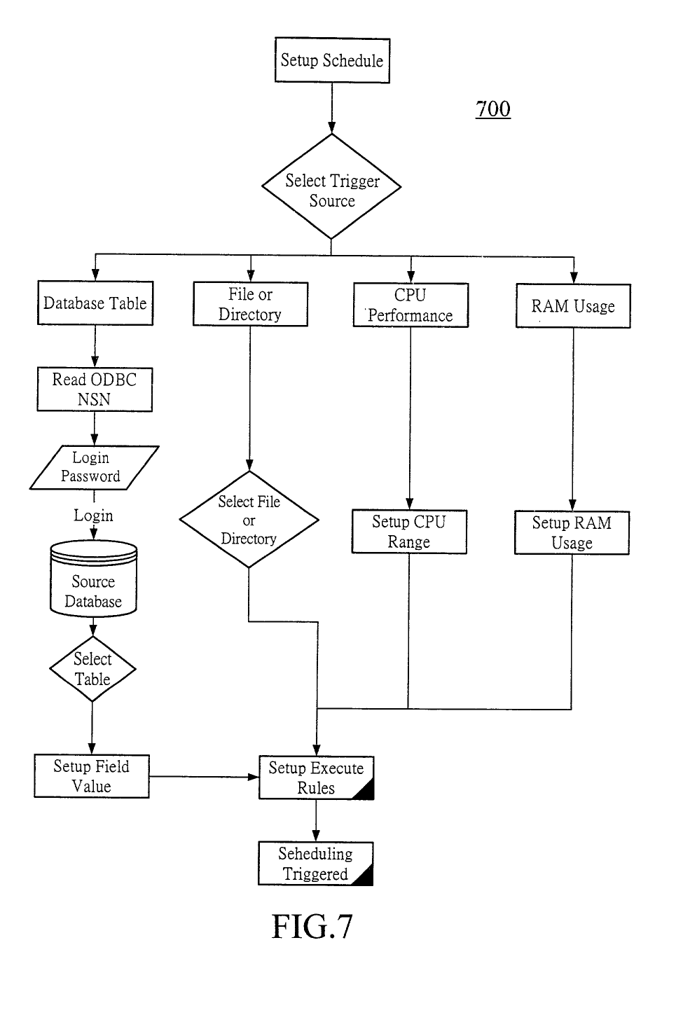

FIG. 7 shows a flowchart 700 of the data rule detecting means of the DBMS in accordance with this invention. The DBMS setups execution schedule and then selects a detection source from database table, a file or directory, a CPU performance, or memory usage. The DBMS then executes the set condition based on the selected detection source. The DBMS then setups execution rules and incorporates into scheduling.

[EMBODIMENTS]

Data migration is a tool program for executing data conversion without writing a program code. The three basic conversion modes are: the conversion between the data tables of large-size databases, such as Sybase, Oracle, SQL server and the PC files, such as DBF and DB; the data transformation between large-size databases, such as SQL server and Oracle; and data transformation between PCs, such as dBASE(.dbf) and Paradox(.db).

An actual procedure of the operation is described as followed:

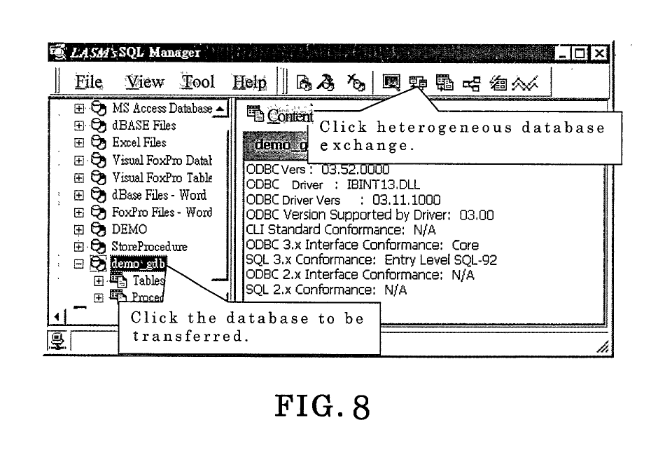

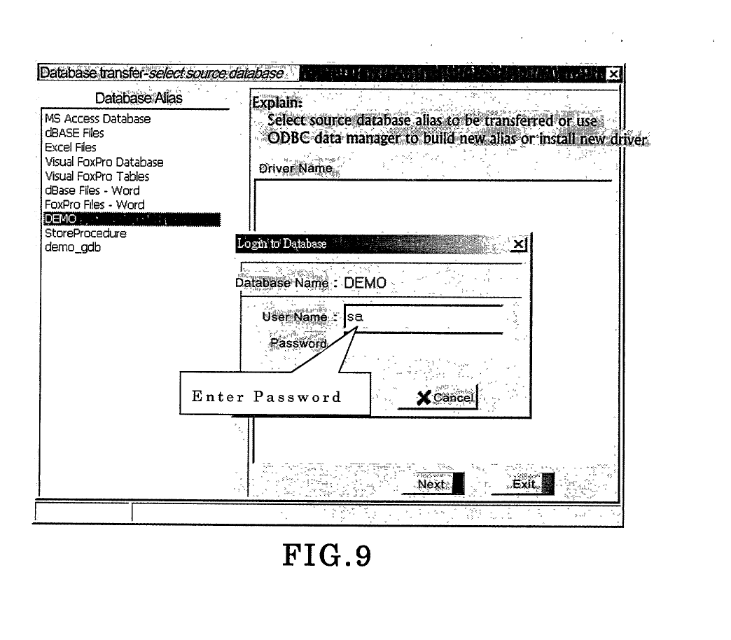

From FIGS. 8 and 9, a database alias to be transferred or moved is respectively selected and a dialog box is shown for the user to enter a username and password.

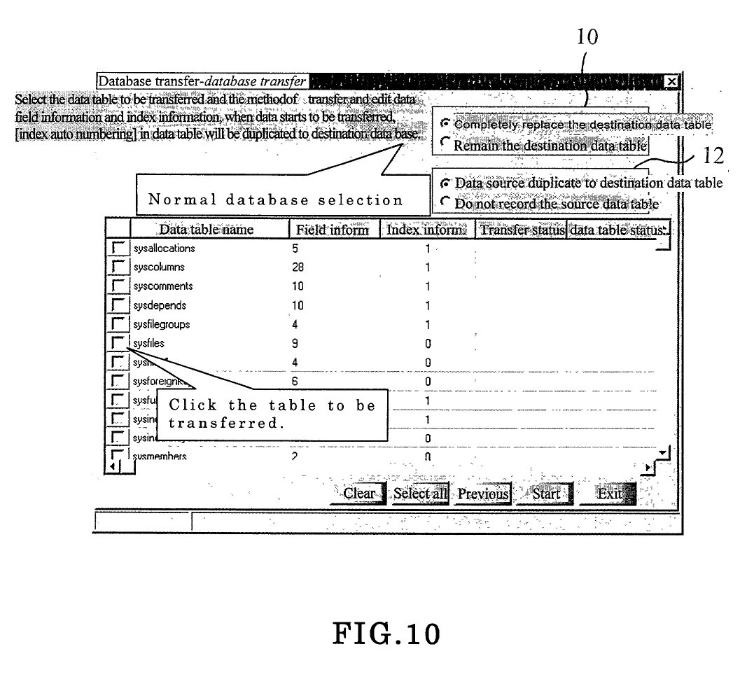

In FIG. 10, a destination data table option box 10 permits the user to disable the current destination data table and change the structure of the data table or to enable the current destination data table. A copy box 12 permits the user to directly copy the source data to the destination data table or not to copy the source data table but execute the conditions of migration of data.

[INQUIRY OF RELATIONAL DATADASE]

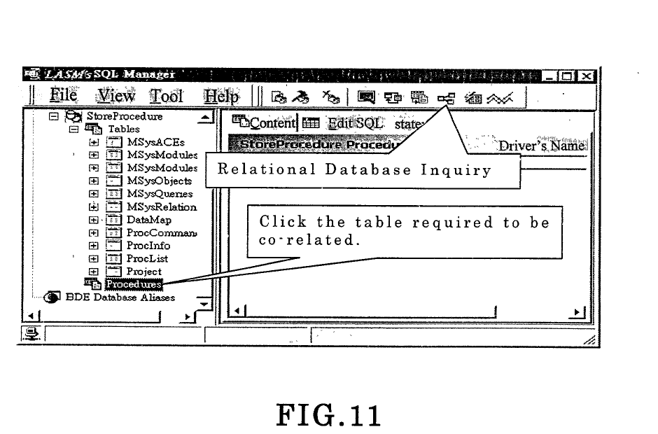

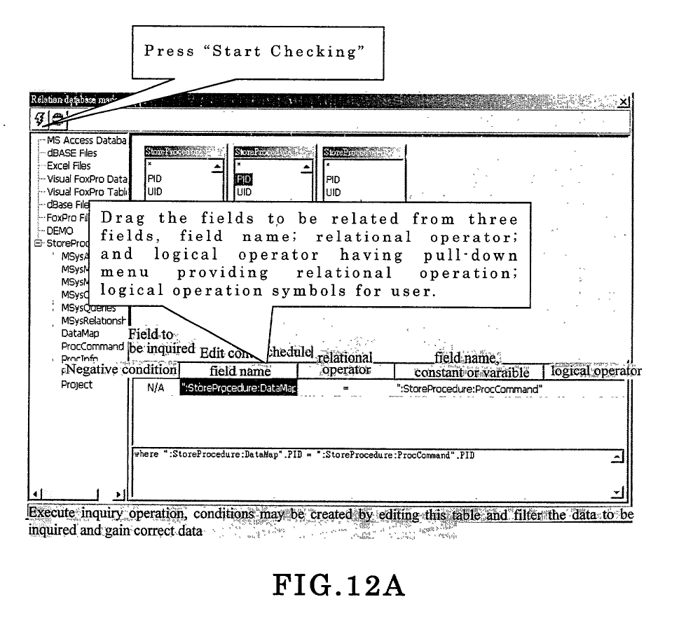

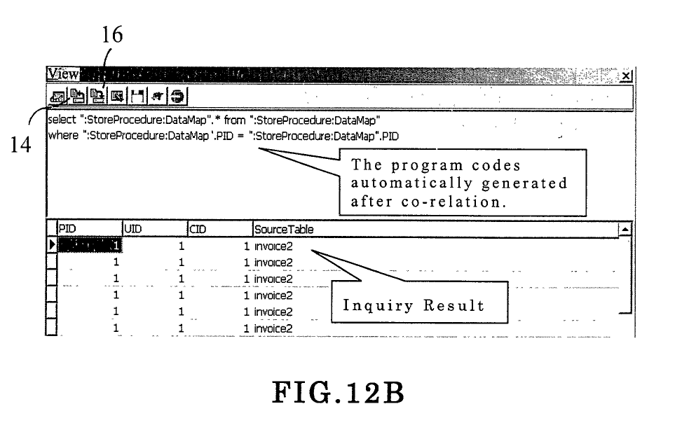

FIGS. 11 and 12A-B show the screens for inquiry of relational database. A phrase of previous edition may be stored and utilized by a next execution for saving time and convenience. If a SQL query is desired to be loaded, then a function key 14 may be selected. If the user intends to store the SQL query, then a function key 16 may be selected.

[SCHEDULING SETTING]

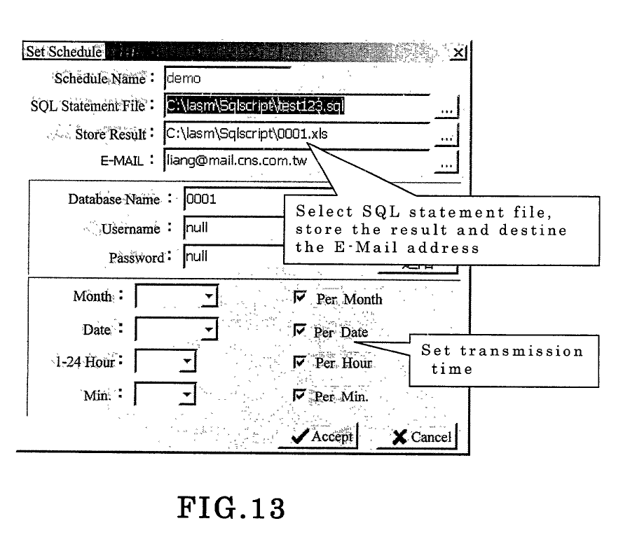

FIG. 13 shows a screen for scheduling setting for setting the time and the timing for transferring data to a specified E-mail address.

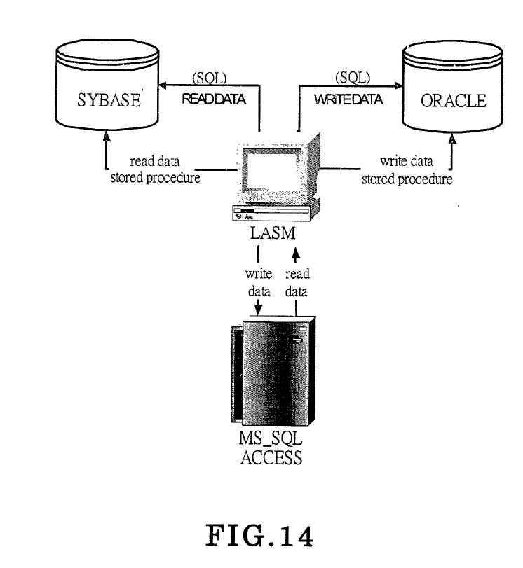

FIG. 14 shows a schematic view of data transfer between Oracle and Sybase.

[ACCESS]

Firstly, data is retrieved from Sybase and then written onto Oracle in a SQL language. The data is then fetched out by Sybase in a store procedure and stored into MS-SQL temporary database. The data is once again fetched out from MS-SQL and filled with parameters in the store procedure of Oracle.

1. Operation of Rule Engine

1.1 The Relation Setup of Table and Field

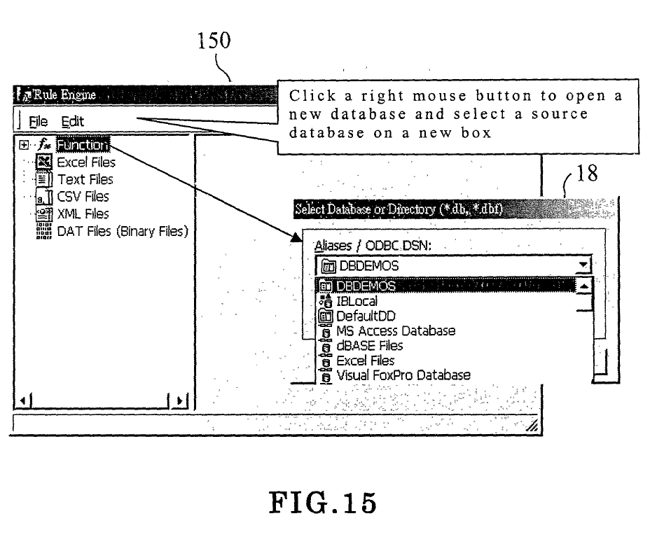

FIG. 15 illustrates a rule engine screen 150, which prompts the user to click a right mouse button to open a new database and the user has to select a source database on a new dialogue box 18.

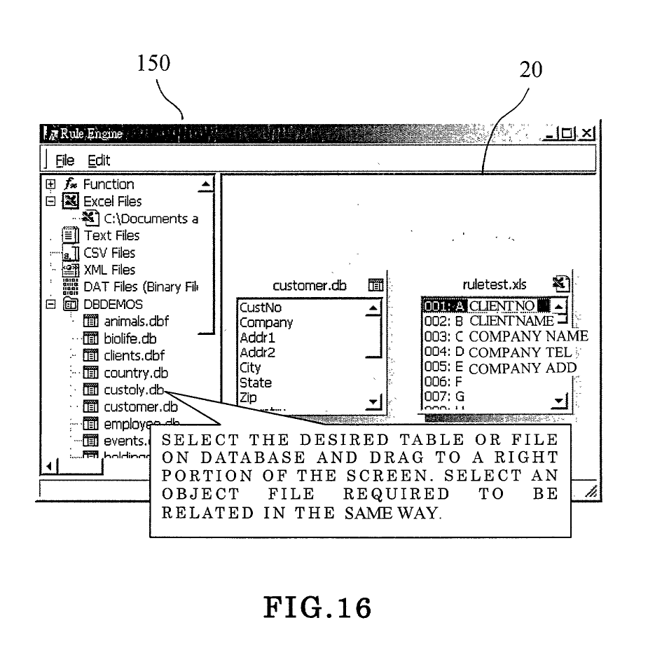

FIG. 16 illustrates the rule engine screen 150, wherein a required table or file is selected from databases and dragged to a right portion 20 of the screen 150. Then, a required relational object file is selected by the same approach.

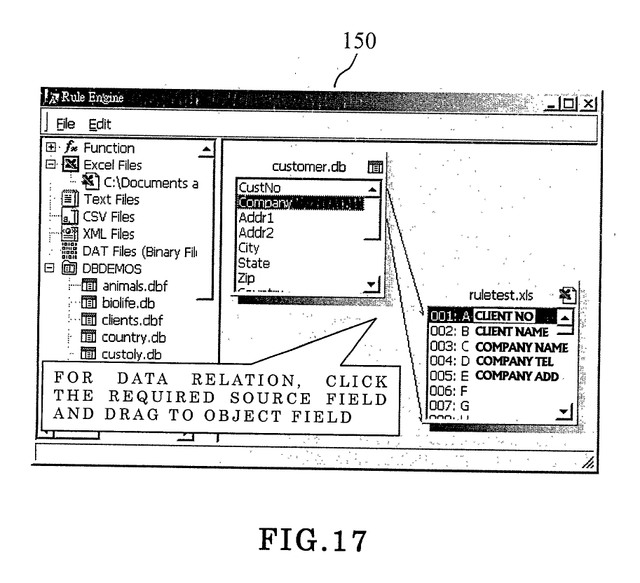

FIG. 17 illustrates the rule engine screen 150, wherein a source field is selected and dragged to a destination field for completing the data relationale. If the user intends to disable the relation between fields, then the destination is selected and the right mouse button is clicked again, the user may select a Remove Link from a pull down menu to disable the relation.

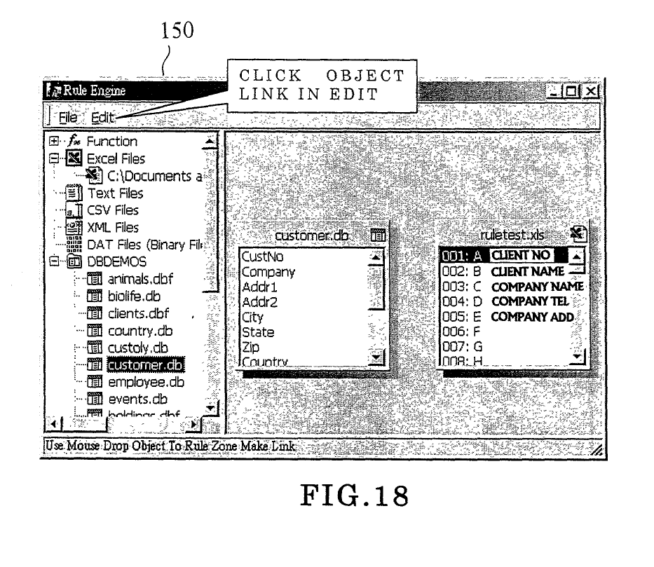

FIG. 18 illustrates the rule engine screen 150, wherein a plurality of fields are to be transferred, a new function is shown for the user to utilize, which is activated by selecting an Object Link from the pull down menu provided by an Edit bar.

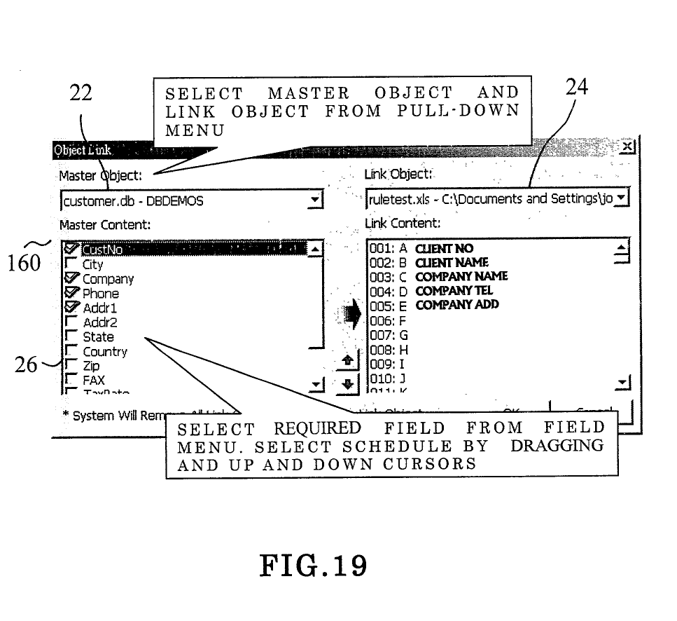

FIG. 19 illustrates the Object Link screen 160 obtained by selecting the Object Link from Edit bar shown in FIG. 18. The screen 160 has a master object line 22 and a link object line 24. The master object line 22 provides a pull down menu 26 for the content of the master object and prompts the user to enter desired fields and reschedule the order the fields.

1.2 The Initialization of the Operation and the Scheduling

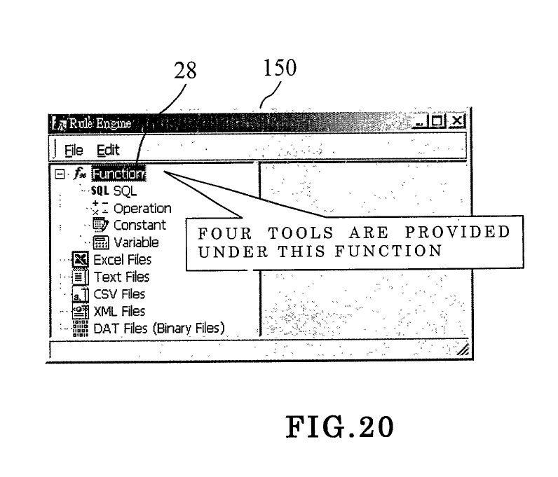

FIG. 20 shows the rule engine screen 150, wherein the field transfer requires additional operation or re-scheduling. As shown, a function bar 28 provides four modes, i.e., SQL mode, Operation mode, Constant mode, and Variable mode.

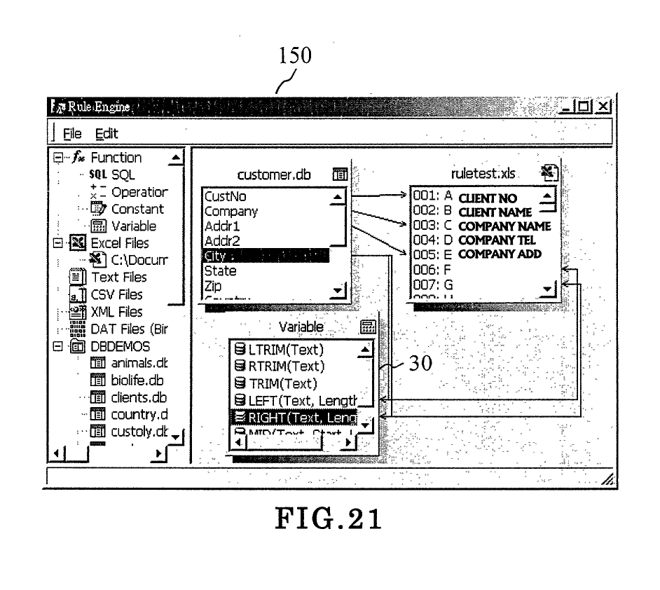

FIG. 21 shows the rule engine screen 150, wherein the variable mode is activated. The screen 150 prompts the user to select a field pointing to LEFT(Text, Length) from the source database. Then, a box 30 would be displayed for the user to enter parameter such that a destination field is pointed by LEFT(Text, Length).

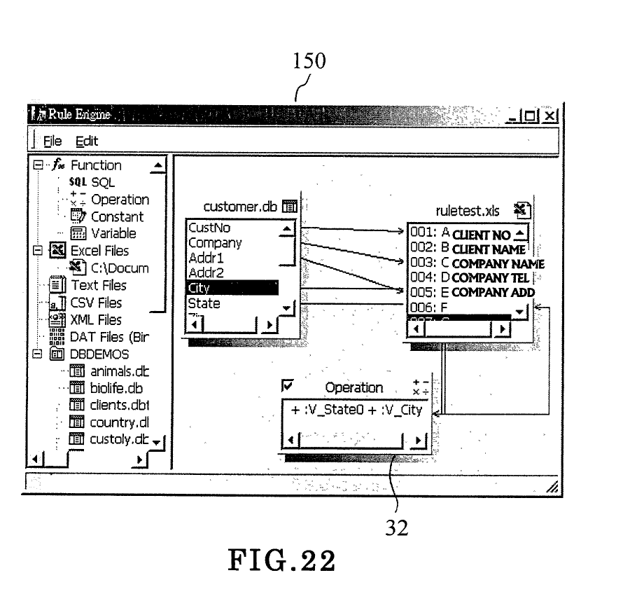

FIG. 22 illustrates the rule engine screen 150, wherein the operation mode is selected. The screen 150 prompts the user to select a plurality of fields required to be operated from the source database and link these fields to operation box 32 for operation. Then, the result is linked to a destination field for output purpose.

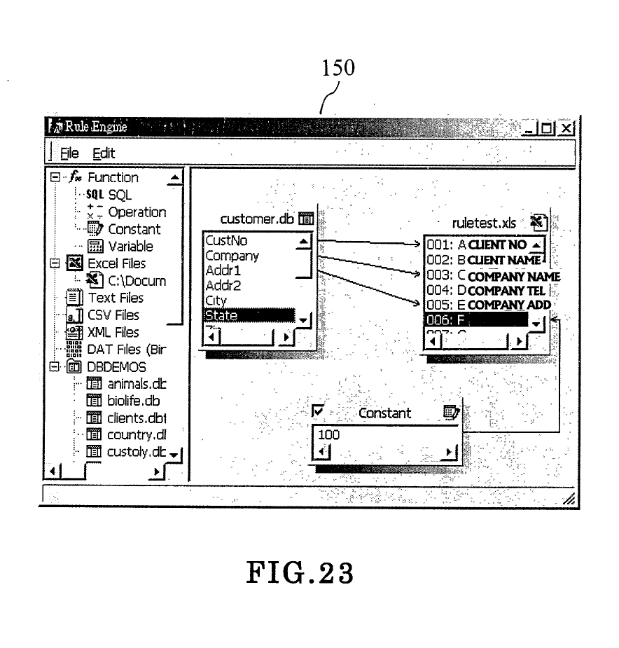

FIG. 23 shows the rule engine screen 150, wherein the Constant mode is selected. The object of this Constant mode is to limit the data displayed by the destination field. The setting may only be directed to destination field and can not accept the setting of the source field.

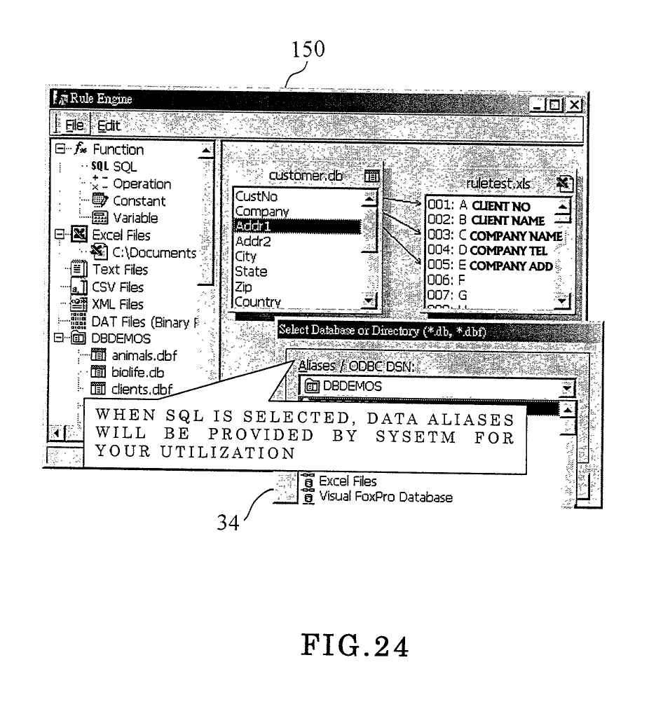

FIG. 24 illustrates the rule engine screen 150, wherein the SQL mode is activated. A box 34 would be displayed for the user to setup the data alias.

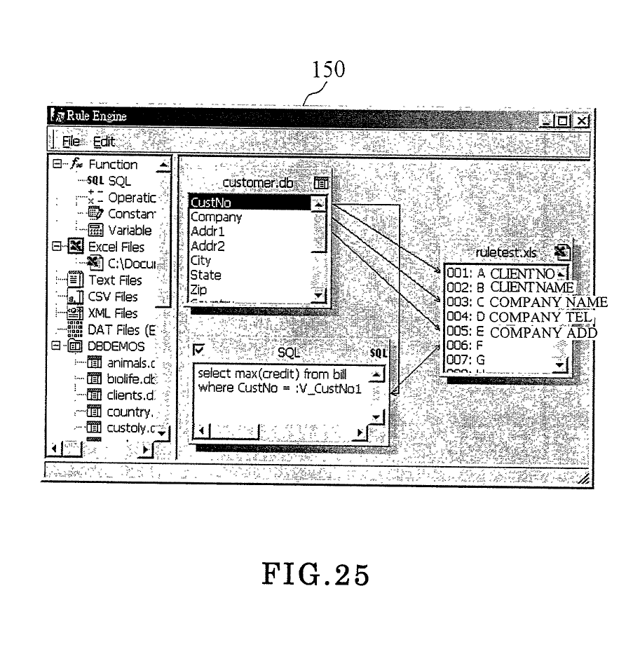

FIG. 25 illustrates the rule engine screen 150, wherein a relationale is built by the same approach. This function facilitates the user to write or modify the SQL language.

[SCHEDULING OF THE PROCEDURE]

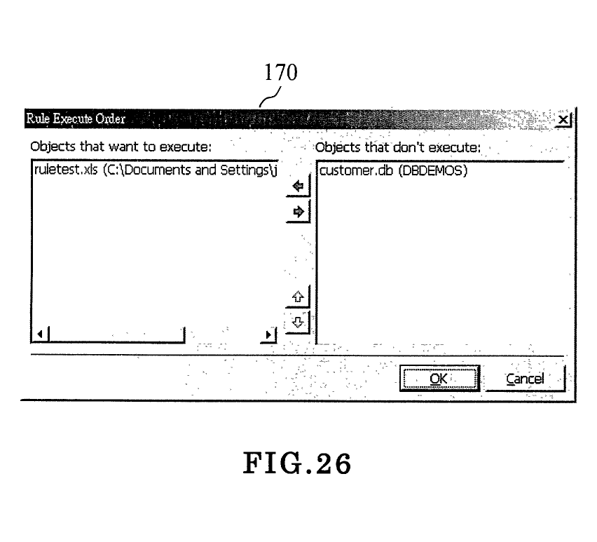

FIG. 26 shows a dialogue box 170 generated by selecting a “Rule Execute Order” in Edit bar of rule engine screen 150. Whether an object to be executed or not is selected and scheduled by a drag function of the mouse.

1.3 The Access and Store of Rule

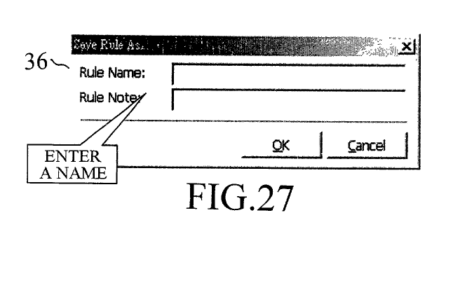

If the user intends to access data, he/she may point to the file bar in the rule engine screen 150 in FIG. 15 and press the left mouse button. A box 36 shown in FIG. 27 would be appeared for the user to enter a directory to be stored, if the user selects a save entry in the menu.

[EMBODIMENT 2]

The following relates to a description and illustration to an AP Launch application of this application.

AP Launch may directly read and store the information (including objects and data) in different application interfaces. AP Launch may further setup the mapping of the selected application component for data copy and exchange. The types of mapping are classified as followed:

Application Interface⇄Application Interface

Application Interface⇄Excel File & Cell

Application Interface⇄Database Record

IE Browser⇄Excel File & Cell

IE Browser⇄Database Record

A special function of AP Launch is that it may automatically click the button on the application screen and write the preset mapping data (from other application, Excel, or Database).

The interface of data access of AP Launch is depended upon the data access interface developed with the Microsoft operation systems (Win9x, Win2000, or Win Me).

AP Launch may directly shows on screen or read data or its element, the user is permitted to rename and store the data field bit generated from the image mapping.

The user may re-define the data of different application program but only one-to-one mapping is permitted. The mapped data may be stored for data exchange with different application programs.

The preset, mapped, or stored data may be revoked during the execution of application program for further operation and directly transformed between application programs.

The mapping or storage of AP Launch is set simultaneously. The system may automatically refresh the result once the data condition is set.

When AP Launch is linked to networks or Electronic Commence system, AP Launch is provided with the following functions:

a. The data on the network or Electronic Commence system may be mapped onto a destined database.

b. The data on the network or Electronic Commence system may be mapped onto a destined Excel field.

The utilization of AP Launch are the followings:

a. Medical resource management: HIS, RIS, and Pacs are integrated into a system screen.

b. Data management: Data from different data sources (web site of the Internet, data base of various application program) are collected, integrated, analyzed, and utilized.

c. Data exchange under different application systems in an industry.

Appendix 1 shows the driver of the software program while Appendix 2 illustrates the operations thereof.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A system for dynamically exchanging heterogeneous databases in real-time, comprising:
database table migration means for executing data migration by selecting a source database and a destination database, and then selecting source data table as a basis for selecting migration mode;
relational table establishing means for defining a displayed relational field and exporting data module after selecting a source database and a source data table;
data table export means for executing data export by selecting source database and selecting an export destination file;
data table import means for executing data import by selecting a source file and selecting destination table according to said source file selection and setting table mapping field;
data mapping rule means for mapping the data field via multiple operation means and an automatically encode and interpretation system after selecting source;
screen data control mapping means for mapping a data file for storage and activating application program by selecting data picture, reading screen element, and setting a name of the element for storage and selecting storage element after selecting data picture; and
data rule detecting means for setting execution rule and importing schedule after setting executing timing, selecting detected source, and selecting target.

2. A system for dynamically exchanging heterogeneous databases in real-time as claimed in claim 1, wherein said source file is a data file.

3. A system for dynamically exchanging heterogeneous databases in real-time as claimed in claim 1, wherein said source file is a spreadsheet file.

4. A system for dynamically exchanging heterogeneous databases in real-time as claimed in claim 1, wherein said source file is a text file.

5. A system for dynamically exchanging heterogeneous databases in real-time as claimed in claim 1, wherein said source file is a XML web page file.

6. A system for dynamically exchanging heterogeneous databases in real-time as claimed in claim 1, wherein said multiple operation is an operation for data table relational.

7. A system for dynamically exchanging heterogeneous databases in real-time as claimed in claim 1, wherein said multiple operation is an operation for functional operation.

8. A system for dynamically exchanging heterogeneous databases in real-time as claimed in claim 1, wherein said multiple operation is an operation for data combination.

9. A system for dynamically exchanging heterogeneous databases in real-time as claimed in claim 1, wherein said multiple operation is an operation for constants.

10. A system for dynamically exchanging heterogeneous databases in real-time as claimed in claim 1, wherein said multiple operation is an operation for variables.

11. A method for dynamically exchanging heterogeneous databases in real-time, comprising the steps of:
transferring database table for executing data migration by selecting a source database and a destination database, and then selecting source data table as a basis for selecting migration mode;
establishing relational table for defining a displayed relational field and exporting data module after selecting a source database and a source data table;
exporting data table for executing data export by selecting source database and selecting an export destination file;
importing data table for executing data import by selecting a source file and selecting destination table according to said source file selection and setting table mapping field;
data mapping rule means for mapping the data field via multiple operation means and an automatically encode and interpretation system after selecting source;
mapping screen data control for mapping a data file for storage and activating application program by selecting data picture, reading screen element, and setting a name of the element for storage and selecting storage element after selecting data picture; and
detecting data rule for setting execution rule and importing schedule after setting executing timing, selecting detected source, and selecting target.
